(19) United States
(12) Patent Application Publication
(10) Pub. No.: US 2008/0010440 A1
(43) Pub. Date: Jan. 10, 2008

(54) MEANS FOR SUPPORTING AND TRACKING A LARGE NUMBER OF IN-FLIGHT STORES IN AN OUT-OF-ORDER PROCESSOR

(75) Inventors: Erik R. Altman, Danbury, CT (US); Vijayalakshmi Srinivasan, New York, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/428,582

(22) Filed: Jul. 5, 2006

(51) Int. Cl. G06F 9/44

(52) U.S. Cl. 712/225

(57) ABSTRACT

A method for supporting and tracking a plurality of stores in an out-of-order processor run by a predetermined program includes executing a plurality of instructions on the processor, each instruction including an address from which data is to be loaded and a plurality of memory locations from which load data is received, determining inputs of the instructions, determining a function unit on which to execute the instructions; storing the plurality of instructions in both a Retirement Store Queue (RSTQ) and a Forwarding Store Queue (FSTQ), the RSTQ comprising a list of the plurality of stores and the FSTQ comprising a list of respective addresses of the plurality of stores, allowing the plurality of stores to be stored in the plurality of memory locations, and allowing the plurality of stores to forward the load data only after the instructions have determined that the predetermined number of the stores has completed the series of the execution processes.

### GOVERNMENT INTEREST

This invention was made with Government support under contract No.: NBCH3039004 awarded by Defense Advanced Research Projects Agency (DARPA). The government has certain rights in this invention.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to out-of-order processors, and particularly to a partition of a storage location (Store Reorder Queue (SRQ)) into two storage locations; one a Retirement Store Queue (RSTQ) and one a Forwarding Storage Queue (FSTQ).

2. Description of Background

In out-of-order processors, instructions may be executed in an order other than what the predetermined program specifies. For an instruction to execute on an out-of-order processor, three conditions normally need to be satisfied: (1) the availability of inputs to the instruction, (2) the availability of a function unit on which to execute the instruction, and (3) the existence of a location to store a result.

For most instructions, these requirements are usually satisfied. However, for load instructions, accurately determining condition (1) is difficult. Load instructions (“loads”) have two types of inputs: (a) registers, which specify an address from which data is to be loaded, and (b) a memory location(s) from which load data is received from. The determination of the availability of register values in case (a) is usually satisfied. However, determining the availability of memory locations in case (b) is not a straightforward determination.

The problem with memory locations is that there may be a plurality of stores in the memory locations that may not have completed their execution and have not stored their values in the memory hierarchy. In addition to checking the memory hierarchy, the load needs to check “in-flight” stores to see if they have updated the location(s) from which the load reads.

An “in-flight” store instruction is one that has been fetched and decoded, but which has not yet been “completed”, i.e., placed its value in the memory hierarchy. “Completed” means that the store and all instructions in the program prior to the store have finished executing, and thus each of these instructions can be represented to the programmer or anyone viewing execution of the program as having completed their execution. The term “retired” is sometimes used as a synonym for “completed.”

Moreover, the problem is to provide an efficient mechanism whereby a load can check in-flight stores to see if data should be forwarded from those stores to the load. The traditional solution to this problem of efficiently forwarding data from in-flight stores to loads is to keep a list of stores that are in some stage of execution. This list is sometimes referred to as the Store Reorder Queue (SRQ). This SRQ list is sorted by the order of stores in the program. Each entry in the SRQ has, among other information, the address(es) at which the store places data in the memory hierarchy. Thus, in the traditional way, each time a load instruction executes a load, it checks the SRQ to determine if any stores which are before the load in program order, generated any data to be written to an address read by the load. If this is the case, the SRQ forwards that data to the load. There may be many stores “in-flight” at any one time: modern processors allow 16, 32, 64 or more stores to be simultaneously “in-flight.” Thus, a load instruction must check 16, 32, 64, or more entries in the SRQ to see if those stores have data, which should be forwarded to the load.

Since new load instructions and store instructions may occur each cycle in a modern processor, these “forwarding” checks must take at most one cycle, i.e., all 16, 32, 64 or more entries in the SRQ must be able to be checked every cycle. Such a “fully associative” comparison is known to be expensive (a) in terms of the area required to perform the comparison, (b) in terms of the amount of energy required to perform the comparison, and (c) in terms of the time required to perform the comparison. In other words, a cycle may have to take longer than it otherwise would so as to allow time for the comparison to complete. All three of these factors are significant concerns in the design of modern processors, and improved solutions are important to continued processor improvement.

Thus, it is well known to forward data from in-flight stores to loads (executed by a load instruction) by keeping a list of stores that are in some stage of execution. However, in existing storage mechanisms since new load instructions may occur each cycle in a modern processor, these “forwarding” checks must (i) take at most one cycle and (ii) entries in the SRQ must be able to be checked every cycle, which is very expensive and time-consuming.

### SUMMARY OF THE INVENTION

The shortcomings of the prior art are overcome and additional advantages are provided through the provision of a method for supporting and tracking a plurality of stores in an out-of-order processor running one or more programs, the method comprising: executing a plurality of instructions on the out-of-order processor, each of the plurality of instructions including an address from which data is to be loaded and a plurality of memory locations from which load data is received from; determining inputs of the plurality of instructions; determining a function unit on which to execute the plurality of instructions; storing the plurality of instructions in both a Retirement Store Queue (RSTQ) and a Forwarding Store Queue (FSTQ), the RSTQ comprising a list of the plurality of stores and the FSTQ comprising a list of respective addresses of the plurality of stores; dividing the FSTQ into a set of congruence classes, each of the congruence classes holding a predetermined number of the plurality of stores; allowing the plurality of stores to be stored in the plurality of memory locations even if the plurality of stores have not completed a series of execution processes; and allowing the plurality of stores to forward the load data only after the plurality of instructions have determined that the predetermined number of the plurality of stores has completed the series of the execution processes.

Additional features and advantages are realized through the techniques of the present invention. Other embodiments and aspects of the invention are described in detail herein and are considered a part of the claimed invention. For a better understanding of the invention with advantages and features, refer to the description.

3. Technical Effects

As a result of the summarized invention, technically we have achieved a solution that employs a dual structure for stores, the purpose of which is to track store order and to allow stores to forward their data to loads.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a store instruction for a dispatch command including an RSTQ (Retirement Store Queue) and a store instruction flowchart;

FIG. 2 illustrates one example of an RSTQ and an FSTQ (Forwarding Store Queue) for a store instruction for an issue command;

FIG. 3 illustrates one example of a flowchart for a store instruction for an issue command;

FIG. 4 illustrates one example of an RSTQ and an FSTQ for a store instruction for a data arrives command;

FIG. 5 illustrates one example of a flowchart for a store instruction for a data arrives command;

FIG. 6 illustrates one example of an RSTQ size; and

FIG. 7 illustrates one example of an FSTQ size.

### DETAILED DESCRIPTION OF THE INVENTION

One aspect of the exemplary embodiments is a dual structure for stores. Another aspect of the exemplary embodiments is a mechanism for tracking store order and for allowing stores to forward their data to loads.

Specifically, the exemplary embodiments of the present application divide the Store Reorder Queue (SRQ) into two parts. The first part is the RSTQ (Retirement Store Queue), which is a list of in-flight stores, sorted by the program order of the stores. However, each entry in the RSTQ can be smaller than an SRQ entry, and in particular need not contain the address to which the store writes its data. As a result, such addresses that store write data are kept in another structure or a second location called the FSTQ. In order to mitigate the problems with area, power, and cycle time described above, the FSTQ has a structure similar to a cache. In particular, the FSTQ is divided into a set of congruence classes, each congruence class being able to hold information concerning a small number (e.g., 4 or 8) stores at any one time. With these congruence classes, loads need only check a small number of stores (e.g., 4 or 8) in order to determine if there is an in-flight store from which the load should have data forwarded. As noted above, the traditional solution must check 16, 32, 64, or more entries in the SRQ to achieve the same ends. In the exemplary embodiments of the present application, as a result of having to check far fewer stores, less area and power is required, and a smaller cycle time can be achieved that is approximately 30-35% improved over previous in-flight stores in out-of-order processors.

The congruence class into which each store is placed in the FSTQ depends on some subset of the bits in the address to which the store writes. Typically the bits determining congruence class are from the lower order bits of the address, as these tend to be more random and help spread entries around, and avoid over-subscribing any particular congruence class. Stores retiring (in program order) from the RSTQ inform the FSTQ that entries can be eliminated. If a congruence class in the FSTQ is full with other store instructions when attempting to add a new store instruction, then this new store instruction may be stalled or rejected, and reissued.

Also, the FSTQ and the RSTQ need to be kept synchronized. The description below discusses mechanisms by which this synchronization is achieved. The detailed solution also discusses how the exemplary embodiments of the present application behave during different phases of load and store execution.

The purpose of the dual structure of the exemplary embodiments of the present application is (1) to track store order and (2) to allow stores to forward their data to loads. The FSTQ is a cache-like structure used to forward data from in-flight stores to load instructions. Like a cache, it has congruence classes determined in the preferred exemplary embodiment by some subset of low order address bits. Below is one embodiment of an FSTQ. Variations on this embodiment for fine tuned control, error detection/correction, etc. would be obvious to anyone skilled in the art.
Structure of FSTQ:
# of Entries: Typically similar to number of RSTQ entries, e.g. 64
Associativity: Small, e.g. 4 or 8
Tags:
A) Upper bits of instruction address—a real address in the preferred embodiment.
B) SSQN(s):
SSQN=Store Sequence Number, i.e., a program ordering of the stores currently in flight between (in order) dispatch and retirement into the cache.

If an FSTQ entry holds only one store, then this field would have only one value. If an FSTQ entry can merge values from multiple stores, this field could have one entry for each byte in the block of data (e.g., 16 SSQN's). These SSQN values can be used as indices into the other major structure, the RSTQ.
C) Valid bit(s):

Like SSQN, if an FSTQ entry holds only one store, then this field would be one bit. If an FSTQ entry can merge values from multiple stores, this field could have up to one entry for each byte in the block of data (e.g. 16 valid bits).
D) Thread number(s):

Like SSQN and the “Valid Bit(s)”, if an FSTQ entry can hold only one store, then this field would be ceil [log 2 (MAX_THREADS)] bits, e.g., log 2(4)=2 bits. If an FSTQ entry can merge values from multiple stores, this field could have up to one entry for each byte in the block of data (e.g. 16*log 2 (MAX_THREADS)=16*2=32 bits.

Furthermore, unlike a traditional cache, the same address could appear multiple times in the same congruence class of the FSTQ. This situation would occur if multiple stores to the same address are simultaneously in flight. The SSQN, thread number, and valid bits indicate which, if any, of the entries should have its value forwarded to a given load.

As far as the structure of the RSTQ is concerned, the RSTQ is a true First-Input First-Output (FIFO) behaving system that permits each of the plurality of stores to enter into a program order executed by the predetermined program only after being decoded. Unlike traditional store queues, the RSTQ has no associative search capability. In fact, the searching is done via the FSTQ.

The RSTQ serves as a place to hold store data until the store completes, as a retirement queue of stores for in-order completion, and as a FIFO queue to determine stores that need to be flushed due to mispredicted branches or other reasons.

Below is one embodiment of an RSTQ. Variations on this embodiment for fine tuned control, error detection/correction, etc., would be obvious to anyone skilled in the art.
Structure of RSTQ:
# of Entries: Typically similar to number of FSTQ entries, e.g. 64
Sequence #: (Can be implicit based on position in RSTQ).
Data: Bytes to be stored at completion time (or forwarded to loads prior to completion). Number of bytes need not be larger than the largest store supported in the architecture, e.g. 16 bytes, and could be less if stores are split, into smaller stores, as would be obvious to anyone skilled in the art.
Mask: Which of the data bytes are to be stored.
Index to FSTQ: Point to block in FSTQ for this store.

If the FSTQ has N entries, then this pointer need not have more than ceil {log 2(N)} bits. For example, if the FSTQ has 64 entries, this pointer could require up to log 2(64)=6 bits. (Note that the RSTQ entry can point directly to the FSTQ entry holding data for the store, and avoid the need for any associative search.)

Global Instruction ID: Useful for flushes due to branch mispredicts and other events.

Moreover, in a processor with Simultaneous Multi-Threading (SMT), the RSTQ could be partitioned among the threads in a manner obvious to anyone skilled in the art, and in much the same manner that a traditional store queue could be partitioned.

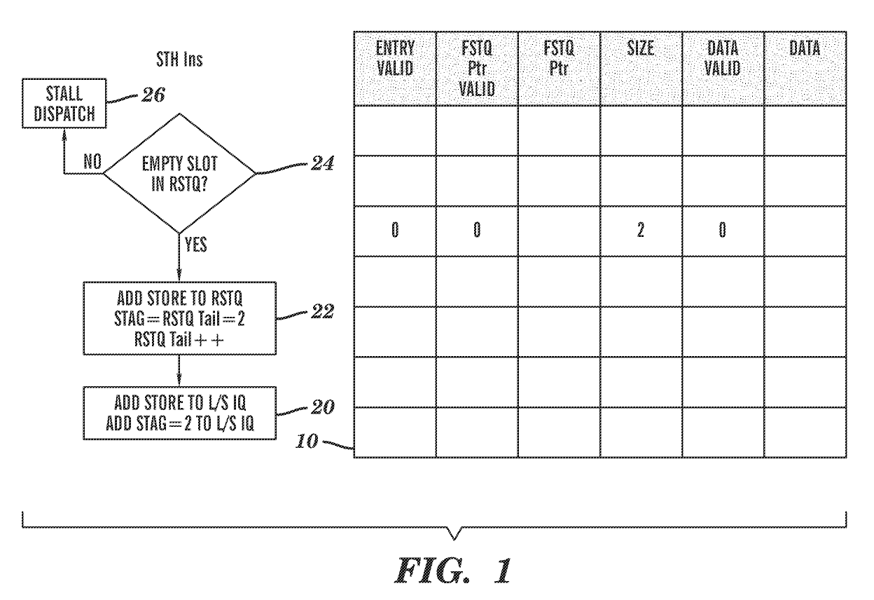

FIG. 1 illustrates one example of the operation of the RSTQ (Table 18) for a store dispatch command and one example of a flowchart for a store instruction for a dispatch command. Table 10 of FIG. 1 receives entries of a store instruction for a dispatch command in columns: Valid, Ptr Valid, FSTQ Ptr, Size, Valid, and Data. FIG. 1 also illustrates the process of executing the dispatch portion of a store instruction. At step 24 it is determined whether the RSTQ contains an empty slot. If no empty slot is determined, then the process flows to step 26 where the store dispatch command is stalled. If an empty slot is determined then the process flows to step 22 where the dispatch command is stored in the RSTQ. Once the dispatch command is stored the process flows to step 20 where the dispatch command is stored in the L/S IQ (Load/Store Instruction Queue).

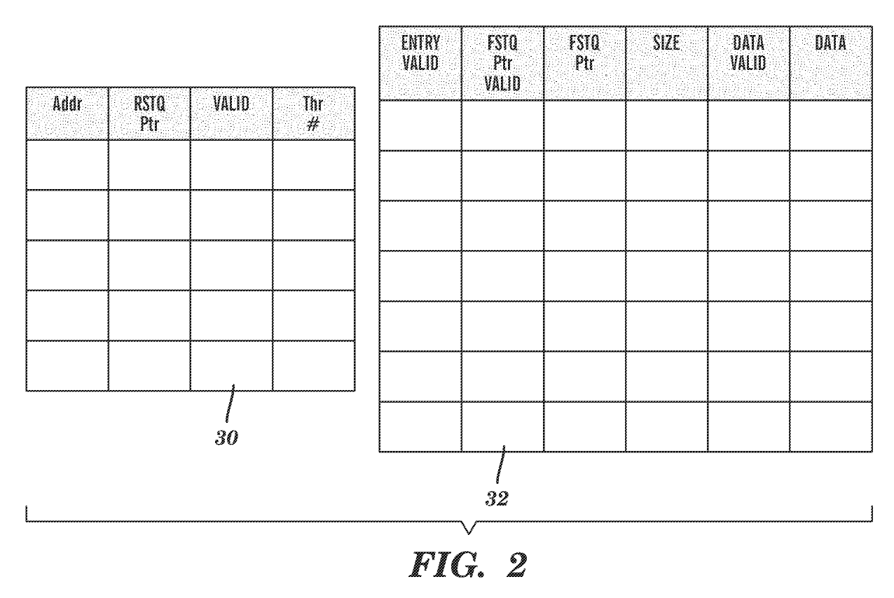

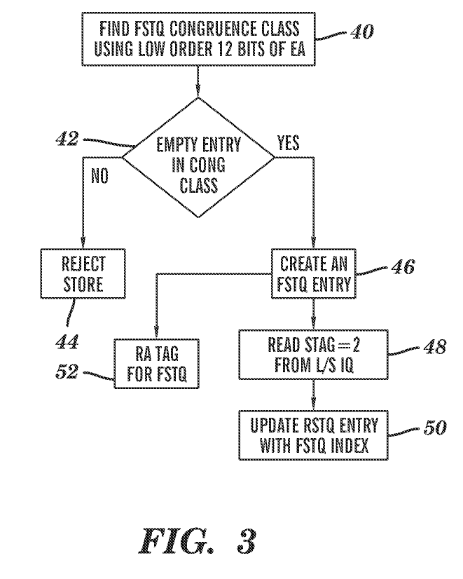

FIG. 2 illustrates one example of the operation of the RSTQ (Table 30) and the FSTQ (Table 32) for a store issue command and FIG. 3 illustrates one example of a flowchart for a store issue command. Table 30 of FIG. 2 receives entries of a store instruction for an issue command in columns: Address, Ptr, Valid, and Number. Table 32 of FIG. 2 receives entries of a store instruction for an issue command in columns: Valid, Ptr Valid, FSTQ Ptr, Size, Valid, and Data. FIG. 3 illustrates the process of executing a store instruction. At step 40 the FSTQ congruence class is determined. At step 42 it is determined if the congruence class contains an empty entry. If there is no empty entry then the process flows to step 44 where the process is terminated. If there is an empty entry then the process flows to step 46 where a FSTQ entry is created. At step 48 the FSTQ entry is read and at step 50 the FSTQ entry is updated with the RSTQ entry read in step 48. Also, when a FSTQ entry is created at step 46 the process flows to step 52 where RA, Tag, and FSTQ entries are entered into table 32 of FIG. 2.

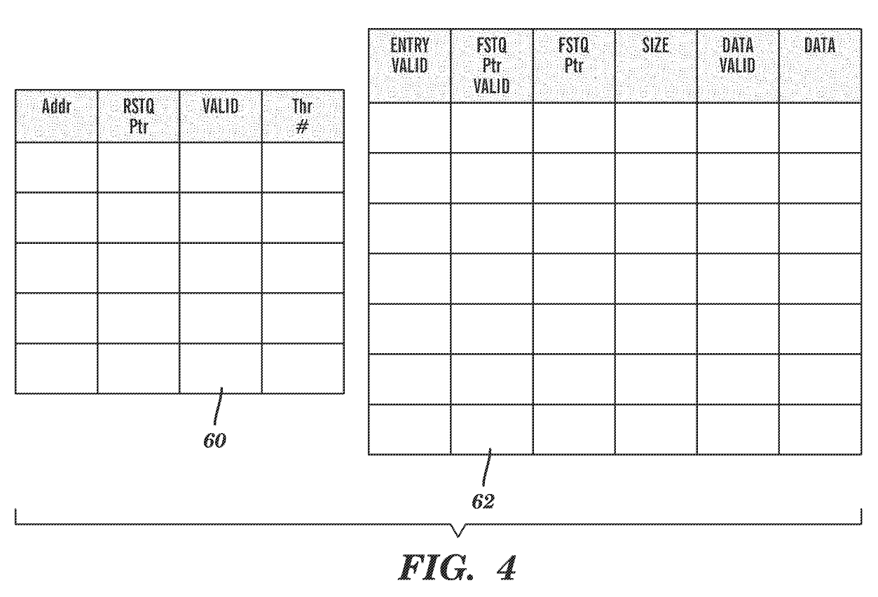

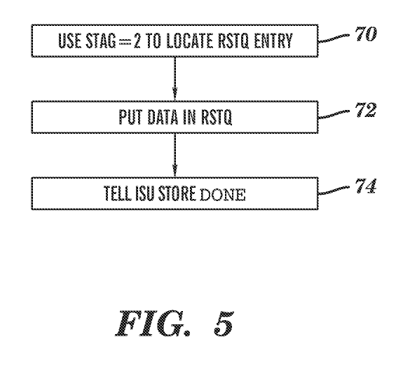

FIG. 4 illustrates one example of the operation of the RSTQ (Table 60) and the FSTQ (Table 62) for a store instruction for which data arrives in the current cycle and FIG. 5 illustrates one example of a flowchart for a store instruction when data arrives in the current cycle. Table 60 of FIG. 4 receives entries of a store instruction for a data arrives command in columns: Address, Ptr, Valid, and Number. Table 62 of FIG. 4 receives entries of a store instruction for a data arrives command in columns: Valid, Ptr Valid, FSTQ Ptr, Size, Valid, and Data. FIG. 5 illustrates the process of executing a store instruction. At step 70 a RSTQ entry is located. At step 72 data is entered into the RSTQ. At step 74 the process is notified that the store process is complete.

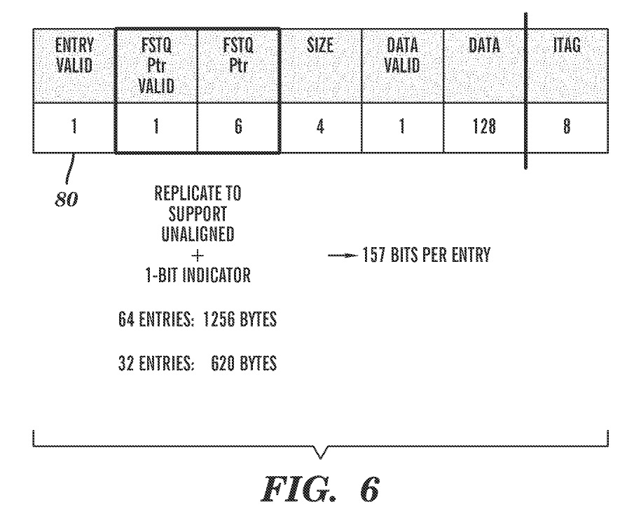

Referring to FIG. 6, a sample size of the RSTQ is shown. For example, for 64 entries into table 30 and table 32 of FIG. 2, the size of the RSTQ is 1256 bytes. For example, for 32 entries into table 30 and table 32 of FIG. 2, the size of the RSTQ is 620 bytes.

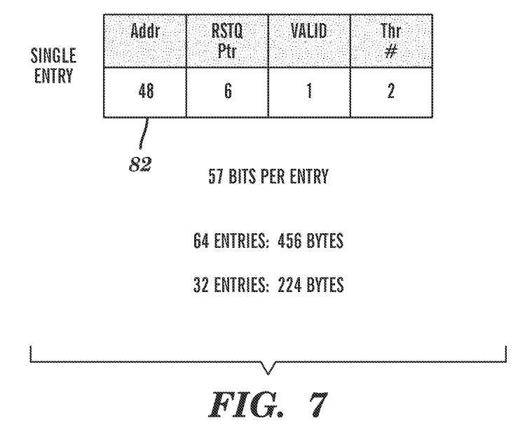

Referring to FIG. 7, a sample size of the FSTQ is shown. For example, for 64 entries into table 60 and table 62 of FIG. 4, the size of the FSTQ is 456 bytes. For example, for 32 entries into table 60 and table 62 of FIG. 4, the size of the FSTQ is 224 bytes.

As far as additional micro-architectural registers are concerned, a power and area efficient implementation of the RSTQ could be implemented as a circular buffer. A circular buffer avoids the need to shift or compact entries. To manage the RSTQ as a circular buffer, at least two micro-architectural registers are useful. One is the RSTQ_TAIL: The location in the RSTQ into which store instructions are initially placed. The other is the RSTQ_HEAD: The location in the RSTQ from which store instructions are removed, with their data placed into the memory hierarchy. Other means of managing a circular buffer or of implementing the RSTQ are obvious to anyone skilled in the art. Likewise, having N RSTQ_TAIL registers and N RSTQ_HEAD registers in an SMT processor with N threads, so as to manage a partitioned RSTQ are obvious to anyone skilled in the art.

In addition, a definition of the actions of each of the structures just defined at key points during execution is provided.

DISPATCH means the placement—in program order—into (issue) queue(s), of an instruction or set of microinstructions corresponding to one architectural instruction.

ISSUE means the launch—not necessarily in program order—of an instruction or microinstruction from an (issue) queue into a function unit capable of executing the instruction. This “launch” includes actual execution of the instruction.

RETIRE means the completion—in program order—of an instruction whose execution has finished, and for which the execution of all prior instructions has finished. Thus, the architected state visible to the programmer or other entity viewing program execution is updated at RETIRE time.

When a DISPATCH store instruction is executed, the following process is followed: (1) If the RSTQ is full, stall dispatch of the store. (2) If the RSTQ is not full, put the store instruction at the RSTQ_TAIL position. Remember this value of RSTQ_TAIL, and then bump the RSTQ_TAIL pointer. The RSTQ_TAIL represents the Store Sequence Number (SSQN), and provides a means of ordering store instructions (as well as load instructions, as described below.) (3) Include the RSTQ_TAIL/SSQN with the store instruction in the Issue Queue from which the store came. The Issue Queue should also pass this SSQN as a tag to the portion of the store that generates the data to be stored.

When an ISSUE store instruction is executed, the following process is followed: (a) Compute the address to which this store writes its data. This address could be a real address or an effective/virtual address. The preferred embodiment is to use a real address, as it avoids problems of synonyms (the same data being available at more than one address). However, management of these structures using effective/virtual addresses are obvious to anyone skilled in the art.

Using the address for this store, and using the SSQN value received from the issue queue (which received it during store DISPATCH, as described above):
Use the SSQN val to find where store should go in RSTQ.
Use the SSQN val and address to find where store should go in FSTQ.
Create/update an FSTQ entry:

If there is no room for a new entry in the FSTQ congruence class, stall the issue of the store or cause it to be reissued later when room may have become available in the RSTQ. In most modern processors, loads expect to be able to receive forwarded data from any store that has issued, but not yet RETIRED.

If an FSTQ entry was created, update the RSTQ entry with the FSTQ index.

(b) When get data for the store, accompanied by the SSQN value as a tag (as described in the discussion of store DISPATCH above):

Use the SSQN val to find where data should go in RSTQ.

Set the Valid bit for this data in the FSTQ.

Moreover, the SSQN value gives a direct address into the RSTQ, and the “Index to FSTQ” field in the RSTQ gives direct access to the corresponding FSTQ entry.

When an RETIRE store instruction is executed, the following process is followed:

Pass the “Index to FSTQ” field of the retiring RSTQ entry to invalidate the corresponding FSTQ entry. (The FSTQ must have a corresponding entry, as the mechanism of this invention keeps the RSTQ and FSTQ contents in lockstep.)

Pass the store address and data to the memory hierarchy, just as is done in traditional store queues at retire time.

Bump the RSTQ_HEAD pointer.

When an RETIRE store instruction is executed, the following process is followed:

Note the value of RSTQ_TAIL register, and include it with the load in this issue queue. Later, when the load issues and checks if any store value should be forwarded from the FSTQ, the check examines stores in priority order starting with stores at SSQN and moving to progressively older stores.

When an ISSUE store instruction is executed, the following process is followed:

Using the address for this load, and using the SSQN value received from the issue queue (which received it during load DISPATCH, as described above):

The address dictates one congruence class in the FSTQ.

Check entries in that congruence class with matching addresses.

Forward the youngest store value that is at least as old as SSQN.

Furthermore, there may be multiple matching addresses in the congruence class. The rule above selects the proper value if there are one or multiple matching addresses. Also, if there are no matching addresses in the FSTQ, the load should obtain data from the caches in the memory hierarchy in the “normal” fashion.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for supporting and tracking a plurality of stores in an out-of-order processor being run by a predetermined program, the method comprising:
executing a plurality of instructions on the out-of-order processor, each of the plurality of instructions including an address from which data is to be loaded and a plurality of memory locations from which load data is received;
determining inputs of the plurality of instructions;
determining a function unit on which to execute the plurality of instructions;
storing the plurality of instructions in both a Retirement Store Queue (RSTQ) and a Forwarding Store Queue (FSTQ), the RSTQ comprising a list of the plurality of stores and the FSTQ comprising a list of respective addresses of the plurality of stores;
dividing the FSTQ into a set of congruence classes, each of the congruence classes holding a predetermined number of the plurality of stores;
allowing the plurality of stores to be stored in the plurality of memory locations even if the plurality of stores have not completed a series of execution processes; and
allowing the plurality of stores to forward the load data only after the plurality of instructions have determined that the predetermined number of the plurality of stores has completed the series of the execution processes.

2. The method of claim 1, wherein the plurality of instructions are load instructions.

3. The method of claim 1, wherein the plurality of instructions are in-flight store instructions.

4. The method of claim 1, wherein the list of the plurality of stores of the RSTQ is a list of in-flight stores, each of the in-flight stores being smaller in size than a Store Reorder Queue (SRQ).

5. The method of claim 1, wherein the FSTQ and the RSTQ are synchronized.

6. The method of claim 1, wherein the FSTQ is a cache-like structure having the congruence classes, each of the congruence classes being a subset of low order address bits, or some other function of the address bits including additional information.

7. The method of claim 1, wherein the FSTQ has searching capabilities.

8. The method of claim 1, wherein the RSTQ is enabled by First-Input First-Output (FIFO) behavior that permits each of the plurality of stores to enter into a program order executed by the predetermined program only after being decoded.

9. The method of claim 1, wherein the RSTQ is implemented by using a circular buffer containing at least two registers, a first of which comprises a location in the RSTQ into which store instructions are initially placed, and a second of which comprises a location in the RSTQ from which store instructions are removed, with the data therefrom placed into a memory hierarchy.
